(19) United States
(12) Patent Application Publication
(10) Pub. No.: US 2018/0338268 A1
(43) Pub. Date: Nov. 22, 2018

(54) METHOD AND APPARATUS FOR PERFORMING APPLICATION CATEGORY BASED TRAFFIC STEERING IN WIRELESS COMMUNICATION SYSTEM

(71) Applicant: LG ELECTRONICS INC., Seoul (KR)

(72) Inventors: Jaewook LEE, Seoul (KR); Youngdae LEE, Seoul (KR); Sunghoon JUNG, Seoul (KR); Sangwon KIM, Seoul (KR); Jaehyun KIM, Seoul (KR)

(21) Appl. No.: 15/777,876

(22) PCT Filed: Nov. 30, 2016
(86) PCT No.: PCT/KR2016/013948

§ 371 Date: May 21, 2018

Related U.S. Application Data
(60) Provisional application No. 62/261,319, filed on Dec. 1, 2015.
(60) Provisional application No. 62/315,007, filed on Mar. 30, 2016.

(51) Int. Cl. H04W 28/08; H04L 12/859

(52) U.S. Cl. CPC H04W 28/08; H04W 84/042; H04L 47/2475

(57) ABSTRACT

A method and apparatus for steering a traffic in a wireless communication system is provided. A user equipment (UE) receives information on traffic in application level from a network, and steers the traffic from a first link to a second link according to the received information. The first link may be an uplink and a second link may be a sidelink, or vice versa. Or, the first link may be a first sidelink and a second link may be a second sidelink. Or, the first link may be a 3rd generation partnership project (3GPP) access network and a second link may be a non-3GPP access network.

### CROSS-REFERENCE TO RELATED APPLICATIONS

This application is the National Stage filing under 35 U.S.C. 371 of International Application No. PCT/KR2016/013948, filed on Nov. 30, 2016, which claims the benefit of U.S. Provisional Applications No. 62/261,319 filed on Dec. 1, 2015, and No. 62/315,007 filed on Mar. 30, 2016, the contents of which are all hereby incorporated by reference herein in their entirety.

### BACKGROUND OF THE INVENTION

### Field of the Invention

The present invention relates to wireless communications, and more particularly, to a method and apparatus for performing an application category based traffic steering in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

3GPP/wireless local area network (WLAN) interworking has been discussed. 3GPP/WLAN interworking may be called traffic steering. From rel-8 of 3GPP LTE, access network discovery and selection functions (ANDSF) for detecting and selecting accessible access networks have been standardized while interworking with non-3GPP access (e.g., WLAN) is introduced. The ANDSF may carry detection information of access networks accessible in location of a user equipment (UE) (e.g., WLAN, WiMAX location information, etc.), inter-system mobility policies (ISMP) which is able to reflect operator's policies, and inter-system routing policy (ISRP). Based on the information described above, the UE may determine which Internet protocol (IP) traffic is transmitted through which access network. The ISMP may include network selection rules for the UE to select one active access network connection (e.g., WLAN or 3GPP). The ISRP may include network selection rules for the UE to select one or more potential active access network connection (e.g., both WLAN and 3GPP). The ISRP may include multiple access connectivity (MAPCON), IP flow mobility (IFOM) and non-seamless WLAN offloading. Open mobile alliance (OMA) device management (DM) may be used for dynamic provision between the ANDSF and the UE.

Recently, besides ANDSF, tighter 3GPP/WLAN interworking in which the network controls the 3GPP/WLAN interworking has been discussed. In the tighter 3GPP/WLAN interworking, the network may provide conditions of triggering 3GPP/WLAN interworking, or may determine which traffic is steered from 3GPP to WLAN or vice versa.

In the tighter 3GPP/WLAN interworking, application category based traffic steering may be required.

### SUMMARY OF THE INVENTION

The present invention provides a method and apparatus for performing an application category based traffic steering in a wireless communication system. The present invention provides a method and apparatus for receiving (un)offloadable application level traffic information and steering traffic from a first link to a second link corresponding to the received (un)offloadable application level traffic information.

In an aspect, a method for steering a traffic by a user equipment (UE) in a wireless communication system is provided. The method includes receiving information on traffic in application level from a network, and steering the traffic from a first link to a second link according to the received information.

In another aspect, a user equipment (UE) in a wireless communication system is provided. The UE includes a memory, a transceiver, and a processor, coupled to the memory and the transceiver, that controls the transceiver to receive information on traffic in application level from a network, and steers the traffic from a first link to a second link according to the received information.

Traffic can be steered based on application level.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows a method for performing traffic steering in application level according to an embodiment of the present invention.

FIG. 7 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

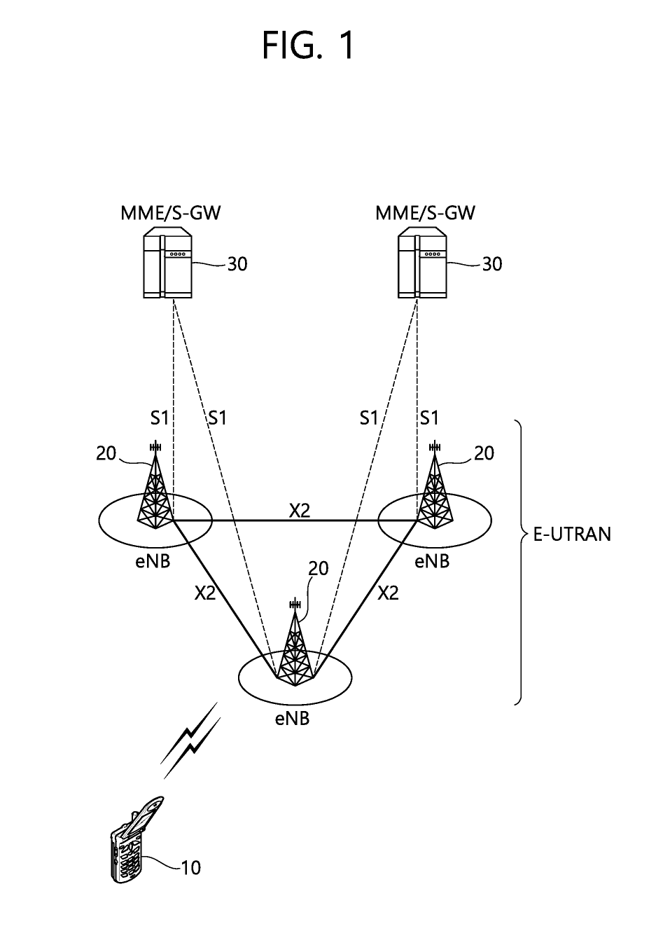

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

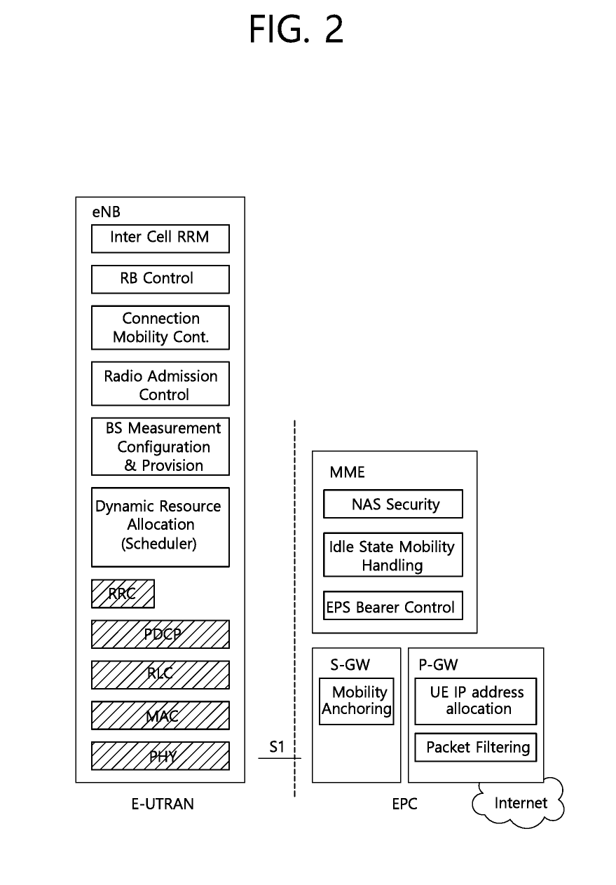

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

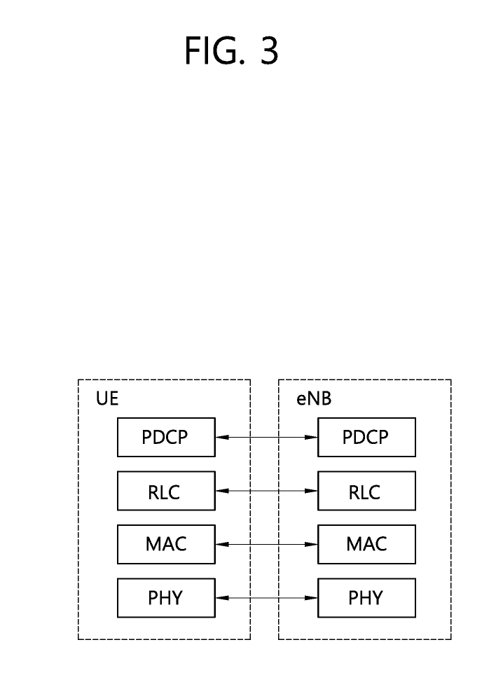

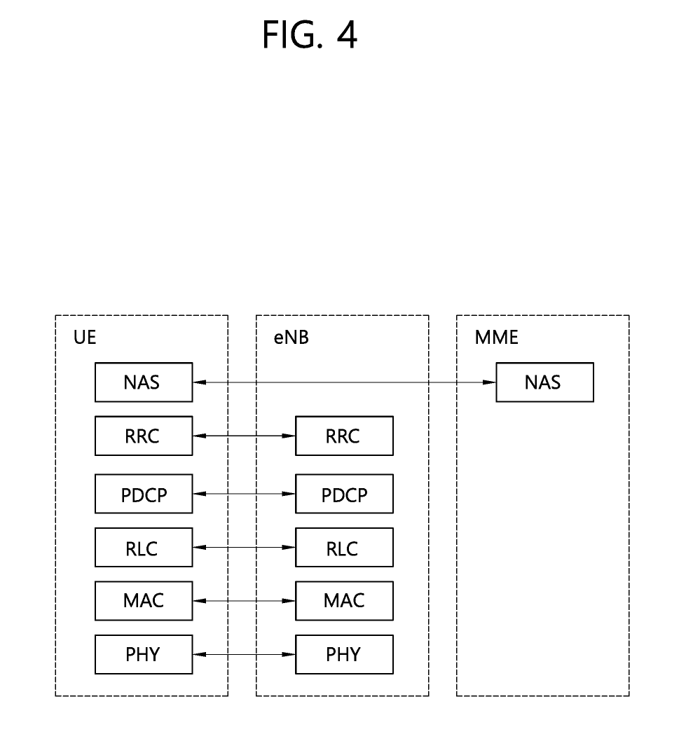

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel The PHY layer is connected to a medium access control (MAC) layer, which is a higher layer of the PHY layer, through a transport channel. A physical channel is mapped to the transport channel. Data between the MAC layer and the PHY layer is transferred through the transport channel Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

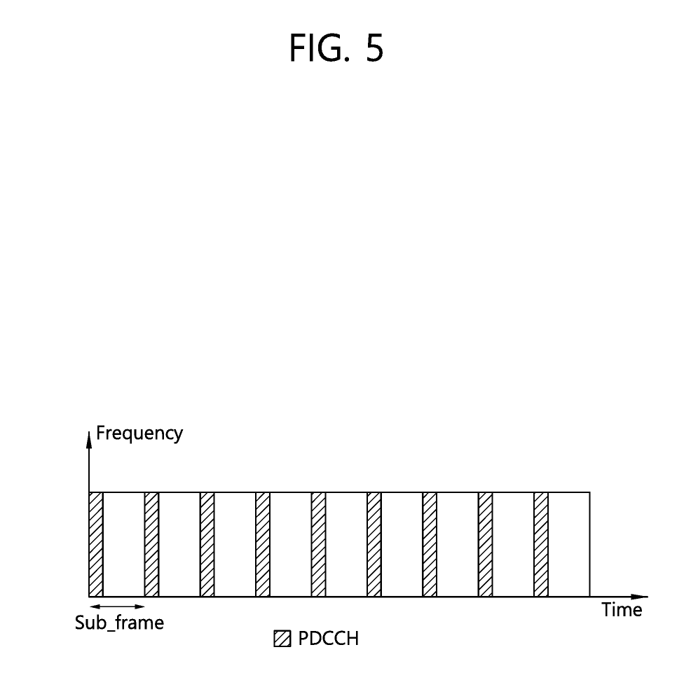

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is lms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, an uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Since rel-8, 3GPP has standardized access network discovery and selection functions (ANDSF), which is for interworking between 3GPP access network and non-3GPP access network (e.g. wireless local area network (WLAN)). The ANDSF management object (MO) is used to manage inter-system mobility policy (ISMP) and inter-system routing policy (ISRP) as well as access network discovery information stored in a UE supporting provisioning of such information from an ANDSF.

The ANDSF may initiate the provision of information from the ANDSF to the UE. The relation between ISMP, ISRP and discovery information is that ISMP prioritize the access network when the UE is not capable to connect to the EPC through multiple accesses, ISRP indicate how to distribute traffic among available accesses when the UE is capable to connect to the EPC through multiple accesses (i.e. the UE is configured for IP flow mobility (IFOM), multiple access connectivity (MAPCON), non-seamless WLAN offload or any combination of these capabilities), while discovery information provide further information for the UE to access the access network defined in the ISMP or in the ISRP. The MO defines validity areas, position of the UE and availability of access networks in terms of geographical coordinates. The UE is not required to switch on all UE's supported radios for deducing its location for ANDSF purposes or for evaluating the validity area condition of a policy or discovery information. The UE shall discard any node which is a child of the ANDSF MO root node and is not supported by the UE. The ANDSF server shall discard any node which is a child of the ANDSF MO root node and is not supported by the ANDSF server.

In addition to ANDSF, additional policy may be specified in RAN specification for interworking between 3GPP access network (e.g. E-UTRAN) and non-3GPP access network (e.g. WLAN). The additional policy for interworking between 3GPP access network and non-3GPP access network may be referred to as RAN rule. Hereinafter, interworking between 3GPP access network (e.g. E-UTRAN) and non-3GPP access network (e.g. WLAN) may be referred to as traffic steering.

RAN-assisted WLAN interworking is described. RAN-assisted WLAN interworking is the mechanism to support traffic steering between E-UTRAN and WLAN. Specifically, RAN-assisted WLAN interworking supports E-UTRAN assisted UE based bi-directional traffic steering between E-UTRAN and WLAN for UEs in RRC_IDLE and RRC_CONNECTED.

E-UTRAN provides assistance parameters via broadcast and dedicated RRC signaling to the UE. The RAN assistance parameters may include E-UTRAN signal strength and quality thresholds, WLAN channel utilization thresholds, WLAN backhaul data rate thresholds, WLAN signal strength and quality thresholds and offload preference indicator (OPI). E-UTRAN can also provide a list of WLAN identifiers to the UE via broadcast signaling. The UE uses the RAN assistance parameters in the evaluation of access network selection and traffic steering rules or ANDSF policies, for traffic steering decisions between E-UTRAN and WLAN. The OPI is only used in ANDSF policies. WLAN identifiers are only used in traffic steering rules.

If the UE is provisioned with ANDSF policies, it shall forward the received RAN assistance parameters to upper layers, otherwise it shall use them in the access network selection and traffic steering rules. The access network selection and traffic steering rules are applied only to the WLANs of which identifiers are provided by the E-UTRAN.

The UE in RRC_CONNECTED shall apply the parameters obtained via dedicated signaling if such have been received from the serving cell. Otherwise, the UE shall apply the parameters obtained via broadcast signaling.

The UE in RRC_IDLE shall keep and apply the parameters obtained via dedicated signaling, until selection/reselection of another cell than the one where these parameters were received or a timer has expired since the UE entered RRC_IDLE upon which the UE shall apply the parameters obtained via broadcast signaling.

In the case of RAN sharing, each PLMN sharing the RAN can provide independent sets of RAN assistance parameters.

The UE indicates to upper layers when (and for which WLAN identifiers along with associated priorities, if any) access network selection and traffic steering rules are fulfilled. The selection among WLANs that fulfil the access network selection and traffic steering rules is up to UE implementation.

When the UE applies the access network selection and traffic steering rules, it performs traffic steering between E-UTRAN WLAN with APN granularity.

RAN-assisted WLAN interworking is described in detail. RAN assistance parameters may be provided to the UE in SystemInformationBlockType17 or in the RRCConnectionReconfiguration message. RAN assistance parameters received in SystemInformationBlockType17 are valid only if the UE is camped on a suitable cell. The UE shall discard the RAN assistance parameters upon cell reselection. Upon T350 expiry, the UE shall discard the RAN assistance parameters received in the RRCConnectionReconfiguration message and apply the RAN assistance parameters received in SystemInformationBlockType17. The UE shall forward to the upper layers the current RAN assistance parameters either when new parameters are received or when parameters are discarded.

Access network selection and traffic steering rules are only applicable for a WLAN for which an identifier has been signaled to the UE by the E-UTRAN and the UE is capable of traffic steering between E-UTRAN and WLAN.

The UE shall indicate to the upper layers when and for which WLAN identifiers the following conditions 1 and 2 for steering traffic from E-UTRAN to WLAN are satisfied for a time interval Tsteering_{WLAN}. Tsteering_{WLAN} specifies the timer value during which the rules should be fulfilled before starting traffic steering between E-UTRAN and WLAN. WLAN identifiers may be service set IDs (SSIDs), basic service set IDs (BSSIDs) or homogeneous extended service set IDs (HESSIDs).

1. In the E-UTRAN serving cell:
RSRPmeas<Thresh_{ServingOffloadWLAN, LowP}; or
RSRQmeas<Thresh_{ServingOffloadWLAN, LowQ};

2. In the target WLAN:
ChannelUtilizationWLAN<Thresh_{ChUtilWLAN, Low}; and
BackhaulRateDlWLAN>Thresh_{BackhRateDLWLAN, High}; and
BackhaulRateU1WLAN>Thresh_{BackhRateULWLAN, High}; and
RCPI>Thresh_{RCPIWLAN, High}; and
RSNI>Thresh_{RSNIWLAN, High};

In the above conditions, RSRPmeas is Qrxlevmeas in RRC_IDLE, which is measured cell RX level value, and primary cell (PCell) reference signal received power (RSRP) in RRC_CONNECTED. RSRQmeas is Qqualmeas in RRC_IDLE, which is measured cell quality value, and PCell reference signal received quality (RSRQ) In RRC_CONNECTED ChannelUtilizationWLAN is WLAN channel utilization. BackhaulRateDlWLAN is WLAN backhaul available DL bandwidth. BackhaulRateUlWLAN is WLAN backhaul available UL bandwidth. RCPI is WLAN received channel power indicator. RSNI is WLAN received signal to noise indicator. Thresh_{ServingOffloadWLAN, LowP} specifies the RSRP threshold (in dBm) used by the UE for traffic steering to WLAN. Thresh_{ServingOffloadWLAN, LowQ} specifies the RSRQ threshold (in dB) used by the UE for traffic steering to WLAN. Thresh_{ChUtilWLAN, Low} specifies the WLAN channel utilization (BSS load) threshold used by the UE for traffic steering to WLAN. Thresh_{BackhRateDLWLAN, High} specifies the backhaul available downlink bandwidth threshold used by the UE for traffic steering to WLAN. Thresh_{BackhRateULWLAN, High} specifies the backhaul available uplink bandwidth threshold used by the UE for traffic steering to WLAN. The above parameters for access network selection and traffic steering between 3GPP and WLAN may be broadcast in system information and are read from the E-UTRAN serving cell. Thresh_{RCPIWLAN, High} specifies the RCPI threshold used by the UE for traffic steering to WLAN. Thresh_{RSNIWLAN, High} specifies the RSNI threshold used by the UE for traffic steering to WLAN.

The UE shall exclude the evaluation of a measurement for which a threshold has not been provided. The UE shall evaluate the E-UTRAN conditions on PCell only. If not all metrics related to the provided thresholds can be acquired for a WLAN, the UE shall exclude that WLAN from the evaluation of the above rule.

Along with the indication, the UE shall indicate to the upper layers the priorities for the WLAN identifiers if provided by the E-UTRAN.

The UE shall indicate to the upper layers when the following conditions 3 or 4 for steering traffic from WLAN to E-UTRAN are satisfied for a time interval Tsteering_{WLAN}:

3. In the source WLAN:
ChannelUtilizationWLAN>Thresh_{ChUtilWLAN, High}; or
BackhaulRateDlWLAN<Thresh_{BackhRateDLWLAN, Low}; or
BackhaulRateUlWLAN<Thresh_{BackhRateULWLAN, Low}; or
RCPI<Thresh_{RCPIWLAN, Low}; or
RSNI<Thresh_{RSNIWLAN, Low};

4. In the target E-UTRAN cell:
RSRPmeas>Thresh_{ServingOffloadWLAN, HighP}; and
RSRQmeas>Thresh_{ServingOffloadWLAN, HighQ};

In the above conditions, Thresh_{ChUtilWLAN, High} specifies the WLAN channel utilization (BSS load) threshold used by the UE for traffic steering to E-UTRAN. Thresh_{BackhRateDLWLAN, Low} specifies the backhaul available downlink bandwidth threshold used by the UE for traffic steering to E-UTRAN. Thresh_{BackhRateULWLAN, Low} specifies the backhaul available uplink bandwidth threshold used by the UE for traffic steering to E-UTRAN. Thresh_{RSNIWLAN, Low} specifies the RCPI threshold used by the UE for traffic steering to E-UTRAN. Thresh_{RSNIWLAN, Low} specifies the RSNI threshold used by the UE for traffic steering to E-UTRAN. Thresh_{ServingOffloadWLAN, HighP} specifies the RSRP threshold (in dBm) used by the UE for traffic steering to E-UTRAN. Thresh_{ServingOffloadWLAN, HighQ} specifies the RSRQ threshold (in dB) used by the UE for traffic steering to E-UTRAN.

The UE shall exclude the evaluation of a measurement for which a threshold has not been provided. The UE shall evaluate the E-UTRAN conditions on PCell only. If not all metrics related to the provided thresholds can be acquired for a WLAN, the UE shall exclude that WLAN from the evaluation of the above rule.

RAN controlled LTE WLAN interworking (RCLWI) is described. RCLWI is a mechanism that E-UTRAN supports E-UTRAN controlled bi-directional traffic steering between E-UTRAN and WLAN for UEs in RRC_CONNECTED. E-UTRAN may send a steering command to the UE and the upper layers in the UE shall be notified upon reception of such a command Higher layers determine which traffic is offloadable to WLAN.

Two scenarios are supported depending on the backhaul connection between LTE and WLAN, i.e. non-collocated RCLWI scenario for a non-ideal backhaul and collocated RCLWI scenario for an ideal/internal backhaul. In the non-collocated RCLWI scenario, the eNB is connected to one or more WLAN termination (WT) logical nodes via an Xw interface. In the collocated RCLWI scenario, the interface between LTE and WLAN is up to implementation.

There is no user plane interface defined between the eNB and the WT in RCLWI. In the non-collocated RCLWI scenario, the Xw control plane interface (Xw-C) is defined between the eNB and the WT.

A WLAN mobility set is a set of one or more BSSID/HESSID/SSIDs, within which WLAN mobility mechanisms apply while the UE has moved offloadable PDN connections to WLAN according to a steering command, i.e. the UE may perform mobility between WLAN APs belonging to the mobility set without informing the eNB.

The UE supporting RCLWI may be configured by the E-UTRAN to perform WLAN measurements. WLAN measurement object can be configured using WLAN identifiers (BSSID, HESSID and SSID), WLAN channel number and WLAN band. WLAN measurement reporting is triggered using received signal strength indicator (RSSI). WLAN measurement report may contain RSSI, channel utilization, station count, admission capacity, backhaul rate and WLAN identifier.

The purpose of the WLAN connection status reporting procedure is to provide feedback to the eNB related to the WLAN status and operation. The WLAN connection status reporting procedure supports the indication of WLAN connection failure. When a UE configured to offload to WLAN becomes unable to establish or continue WLAN offloading, the UE sends the WLANConnectionStatusReport message to indicate “WLAN connection failure” to the eNB. The UE is not required to send the WLANConnectionStatusReport message if it successfully re-associates to another AP within the WLAN mobility set. The criteria to determine WLAN connection failure is left for UE implementation.

Sidelink is UE to UE interface for proximity-based services (ProSe) direct communication, ProSe direct discovery and vehicle-to-everything (V2X) sidelink communication. Sidelink comprises ProSe direct discovery, ProSe direct communication and V2X sidelink communication between UEs. Sidelink uses UL resources and physical channel structure similar to UL transmissions. Sidelink transmission uses the same basic transmission scheme as the UL transmission scheme. However, sidelink is limited to single cluster transmissions for all the sidelink physical channels. Further, sidelink uses a 1 symbol gap at the end of each sidelink sub-frame.

ProSe direct communication and V2X sidelink communication are a mode of communication whereby UEs can communicate with each other directly over the PC5 interface. This communication mode is supported when the UE is served by E-UTRAN and when the UE is outside of E-UTRA coverage. Only those UEs authorized to be used for public safety operation can perform ProSe direct communication.

ProSe direct discovery is defined as the procedure used by the UE supporting ProSe direct discovery to discover other UE(s) in its proximity, using E-UTRA direct radio signals via PC5. ProSe direct discovery is supported only when the UE is served by E-UTRAN. Upper layer handles authorization for announcement and monitoring of discovery message. Content of discovery message is transparent to AS and no distinction in AS is made for ProSe direct discovery models and types of ProSe direct discovery. The ProSe protocol ensures that only valid discovery messages are delivered to AS for announcement.

By using concept of ProSe function, the extension of network coverage using L3-based UE-to-Network Relay and/or UE-to-UE Relay have been discussed. In the UE-to-Network Relay, a relay UE provides functionality to support connectivity to unicast services for remote UE(s). A remote UE is a ProSe-enabled public safety UE that communicates with a PDN via a UE-to-Network Relay. That is, the relay UE may receive control signal/data from the remote UE, which is required to be relayed to the network or another UE. If the control signal/data is relayed to the network, it may consist of UE-to-Network Relay. If the control signal/data is relayed to another UE, it may consist of UE-to-UE Relay.

The UE supporting sidelink remote operation may evaluate the AS-layer conditions that need to be met in order for upper layers to configure a remote UE to receive/transmit relay related sidelink discovery/communication. The AS-layer conditions merely comprise of being configured with radio resources that can be used for transmission, as well as whether or not having a selected relay.

The remote UE may select or reselect the relay UE. A UE capable of sidelink remote operation that is configured by upper layers to search for a sidelink relay shall:

1> if out of coverage on the frequency used for sidelink communication; or

1> if the serving frequency is used for sidelink communication and the reference signal received power (RSRP) measurement of the cell on which the UE camps (RRC_IDLE)/the primary cell (PCell) (RRC_CONNECTED) is below discThreshHiRemoteUE:

2> search for candidate relays;

2> when evaluating the one or more detected relays, apply layer 3 filtering across measurements that concern the same ProSe Relay UE ID and using the preconfigured filterCoefficient, before using the SD-RSRP measurement results;

2> if the UE does not have a selected relay:

3> select a candidate relay which sidelink discovery (SD-RSRP) exceeds q-RxLevMin included in either reselectionInfoRemoteUE-IC (in coverage) or reselectionInfoRemoteUE-OC (out of coverage) by minHyst;

2> else if SD-RSRP of the currently selected relay is below q-RxLevMin included in either reselectionInfoRemoteUE-IC (in coverage) or reselectionInfoRemoteUE-OC (out of coverage); or

2> else upper layers indicate not to use the currently selected relay: (i.e. relay reselection):

3> select a candidate relay which SD-RSRP exceeds q-RxLevMin included in either reselectionlnfoRemoteUE-IC (in coverage) or reselectionInfoRemoteUE-OC (out of coverage) by minHyst;

2> else if the UE did not detect any candidate relay which SD-RSRP exceeds q-RxLevMin included in either reselectionInfoRemoteUE-IC (in coverage) or reselectionInfoRemoteUE-OC (out of coverage) by minHyst:

3> consider no relay to be selected;

The UE may perform relay reselection in a manner resulting in selection of the sidelink relay, amongst all candidate relays meeting higher layer criteria, that has the best radio link quality.

ANDSF provides traffic steering mechanism in application level. That is, traffic steering can be performed for each application. However, RAN rules specified in RAN-assisted WLAN interworking or RCLWI only provides traffic steering mechanisms in APN level. Hence, application specific traffic steering is not possible in the network that only supports RAN rules or RCLWI but do not support ANDSF. However, even in RAN-assisted WLAN interworking or RCLWI, there is need to perform traffic steering in application level.

Accordingly, application level traffic steering mechanism is proposed according the present invention. According to an embodiment of the present invention, the UE receives information on offloadable (or, unoffloadable) application level traffic and steers the traffic corresponding to the received information from a first link to the second link. The first link may be an uplink (i.e. Uu interface) and the second link may be a sidelink (based on PC5 interface or non-3GPP access (e.g. Wi-Fi or Bluetooth)), or vice versa. In the case, traffic can be steered in application level between uplink and sidelink. Or, the first link and the second link may be both sidelinks. In the case, traffic can be steered in application level between sidelinks. Or, the first link may be 3GPP access network (e.g. LTE) and the second link may be non-3GPP access network (e.g. WLAN), or vice versa. In this case, traffic can be steered in application level between 3GPP access network and non-3GPP access network if interworking conditions for traffic steering from 3GPP access network to non-3GPP access network (or, vice versa) are met.

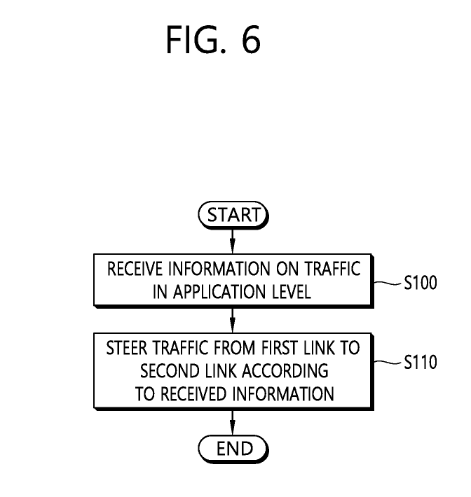

FIG. 6 shows a method for performing traffic steering in application level according to an embodiment of the present invention. For the sake of convenience, this embodiment will be generally described for traffic steering between 3GPP access network (i.e. 3GPP LTE) and non-3GPP access network (i.e. WLAN). However, this embodiment is merely exemplary, and the present invention may be generally applied to traffic steering between a first link and a second link (e.g. between uplink and sidelink or between sidelinks), as described above.

In step S100, the UE receives information on traffic in application level. The network may provide offloadable (or, unoffloadable) application level traffic information to the UE via dedicated signaling or broadcast signaling. If the application level traffic information is provided via dedicated signaling, the UE may apply the application level traffic information provided via dedicated signaling. Otherwise, the UE may apply the application level traffic information provided via broadcast signaling. Alternatively, if the application level traffic information provided via dedicated signaling is absent, the UE may not apply any application level traffic information provided via broadcast signaling. Or, the application level traffic information may be provided via NAS signaling from core network to the UE when the UE performs an attach procedure or a tracking area update (TAU) procedure.

The offloadable (or, unoffloadable) application level traffic information may include identifiers of (un)offloadable application. Further, the offloadable (or, unoffloadable) application level traffic information may include an indication of whether a certain category of applications are allowed to be offloaded or not. More specifically, the offloadable application level traffic information may indicate which application level traffic can be steered between the first link and second link. Or, the offloadable application level traffic information may indicate which category of application can be steered between the first link and second link. The unoffloadable application level traffic information may indicate which application level traffic cannot be steered between the first link and second link. Or, the unoffloadable application level traffic information may indicate which category of application cannot be steered between the first link and second link.

Each application may be categorized into a specific category. The categorization may be same as the categorization of application specific congestion control for data communication (ACDC). Each application may be identified by APP-ID and the APP-ID may be further identified by OS Id, OS Application Id. The information on category may be provided to the UE via OMA-DM signaling. Or, the information on category may be provided in the universal subscriber identification module (USIM) of the UE. For uncategorized application, the UE may consider the uncategorized application as always offloadable (or, unoffloadable). Or, the UE may implicitly consider the uncategorized application belongs to one of other category (e.g. first category or last category). For application which is categorized but not signaled, the UE may always consider the corresponding application as offloadable or unoffloadable.

The indication of whether a certain category of applications are allowed to be offloaded or not may be provided per PLMN if RAN is shared by multiple PLMNs. In this case, the indication of whether a certain category of applications are allowed to be offloaded or not per PLMN may be provided in the same order as in PLMN list in SIB1 so that the PLMN identity may not need to be provided. Alternatively, explicit relationship between the indication of whether a certain category of applications are allowed to be offloaded or not and each PLMN may be provided.

Further, the offloadable (or, unoffloadable) application level traffic information may be provided separately for a roaming UE and non-roaming UE. If roaming UE specific application level traffic information is provided, the roaming UE may apply the corresponding information for determining which traffic is allowed to be offloaded or not. If there is no roaming UE specific application level traffic information, the UE may apply application level traffic information corresponding to the registered PLMN.

For traffic steering between LTE and WLAN, the application level traffic information may be provided via assistance information for access network selection and traffic steering rules. Alternatively, the application level traffic information may be provided in command for RCLWI. Alternatively, the application level traffic information may be provided via other access network and traffic steering policy (e.g. ANDSF).

Back to FIG. 6, in step S110, the UE steers traffic from a first link to a second link according to the received application level traffic information. For example, the UE may steer traffic from uplink to sidelink (or, vice versa) according to the received application level traffic information. For example, the UE may steer traffic from a first sidelink to a second sidelink according to the received application level traffic information.

For example, for traffic steering between LTE and WLAN, upon receiving the offloadable (or, unoffloadable) application level traffic information, the UE may perform access network selection and traffic steering as follows.

1) For RAN rule, after receiving the offloadable (or, unoffloadable) application level traffic information and thresholds for access network selection and traffic steering rules specified in Rel-12, the UE may evaluate the access network selection and traffic steering rules. If conditions for traffic steering from 3GPP access network to non-3GPP access network are satisfied for a certain time period, the UE may steer traffic associated with the indicated offloadable applications. If the category information is provided by the network for indicating which category is offloadable or not, the UE may steer applications to the non-3GPP access network associated with the indicated categories (or offloading allowed categories). If conditions for traffic steering from non-3GPP access network to 3GPP access network are satisfied for a certain time period, the UE may steer back to the 3GPP access network all the traffic which were already steered to the non-3GPP access network.

2) For RCLWI, after receiving the offloadable (or, unoffloadable) application level traffic information and command for steering traffic from 3GPP access network to non-3GPP access network (or steering traffic from non-3GPP access network to 3GPP access network), the UE may steer traffic associated with the indicated offloadable applications to non-3GPP access network (or 3GPP access network). If the category information is provided by the network, the UE may steer applications to the non-3GPP access network (or 3GPP access network) associated with the indicated categories (or categories allowed to be offloaded). In case of command for steering traffic from non-3GPP access network to 3GPP access network, if the offloable (or, unoffloadable) applicable level traffic information is absent, the UE may steer all the traffic already steered to non-3GPP access network.

3) For ANDSF, if the UE capable of ANDSF and not capable of any RAN solutions (e.g. access network selection and traffic steering rules and/or RCWLI) is provided the offloadable (or, unoffloadable) application level traffic information, the UE may provide the received application level traffic information to the upper layer. The upper layer may utilize both the received application level traffic information and information in ANDSF, which will be described below.

4) For relay selection rule, after receiving the offloadable (or, unoffloadable) application level traffic information and thresholds for relay (re)selection specified in Rel-13, the UE may evaluate the relay (re)selection rule. If conditions for relay (re)selection rules are satisfied, the UE may steer traffic associated with the indicated offloadable applications to the (re)selected relay. If the category information is provided by the network for indicating which category is offloadable or not, the UE may steer applications associated with the indicated categories (or offloading allowed categories) to the non-3GPP access network. If conditions for traffic steering from relay to direct Uu connection are satisfied, the UE may steer back to the Uu connection all the traffic which were already steered to the (re)selected relay.

The UE may be provided with multiple traffic information. For example, the UE may be provided with the offloadable (or, unoffloadable) application level traffic information according to an embodiment of the present invention and other offloadable (or, unoffloadable) PDN connection/IP flow/bearer/application traffic information. Examples of the other offloadable (or, unoffloadable) traffic information may include offloadable (or, unoffloadable) PDN connectivity traffic information provided for access network selection and traffic steering (i.e. RAN rule), or bearer traffic information provided for RCLWI, or other offloable (or, unoffloadable) traffic information provided in ANDSF. In this case, one of the following options may be used for applying the traffic information.

1) The UE may ignore other offloadable (or, unoffloadable) PDN connection/IP flow/bearer/application information and may follow only the offloadable (or, unoffloadable) application level traffic information.

2) If traffic belongs to multiple traffic information, the UE may consider the traffic is offloadable only when all multiple traffic information indicates that the traffic is offloadable. If at least one of the multiple traffic information indicates that the traffic is unoffloadable, the UE may consider the traffic is unoffloadable.

If traffic belongs to only one traffic information, the UE may consider the traffic is offloadable or unoffloable according to that one traffic information.

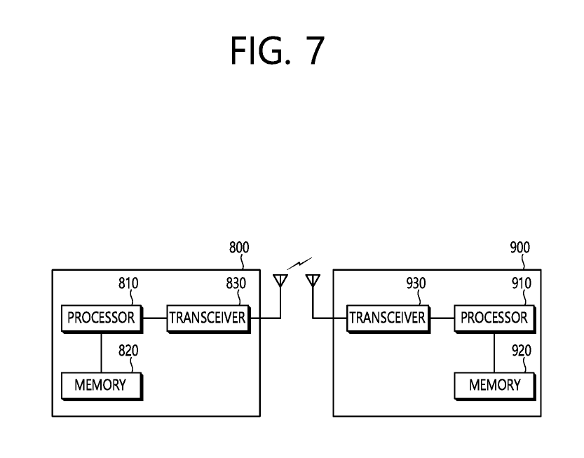

FIG. 7 shows a wireless communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for steering a traffic by a user equipment (UE) in a wireless communication system, the method comprising:
receiving information on traffic in application level from a network; and
steering the traffic from a first link to a second link according to the received information.

2. The method of claim 1, wherein the first link is an uplink and a second link is a sidelink, or vice versa.

3. The method of claim 1, wherein the first link is a first sidelink and a second link is a second sidelink.

4. The method of claim 1, wherein the first link is a 3rd generation partnership project (3GPP) access network and a second link is a non-3GPP access network.

5. The method of claim 1, wherein the information on traffic in application level includes identifiers of applications.

6. The method of claim 1, wherein the information on traffic in application level includes an indication of whether a certain category of applications are allowed to be offloaded or not from the first link to the second link.

7. The method of claim 6, wherein information on the certain category is provided via open mobile alliance (OMA) device management (DM) signaling or in a universal subscriber identification module (USIM) of the UE.

8. The method of claim 6, wherein the indication of whether a certain category of applications are allowed to be offloaded or not is configured per public land mobile network (PLMN).

9. The method of claim 1, wherein the information on traffic in application level is configured separately for a roaming UE and a non-roaming UE.

10. The method of claim 1, wherein the information on traffic in application level is received via dedicated signaling or broadcast signaling.

11. The method of claim 1, wherein the information on traffic in application level is received via non-access stratum (NAS) signaling when the UE performs an attach procedure or a tracking area update (TAU) procedure.

12. The method of claim 1, wherein the information on traffic in application level is received via one of assistance information for access network selection and traffic steering rules, a command for radio access network (RAN) controlled long-term evolution (LTE) wireless local area network (WLAN) interworking (RCLWI), or access network discovery and selection functions (ANDSF).

13. A user equipment (UE) in a wireless communication system, the UE comprising:
a memory;
a transceiver; and
a processor, coupled to the memory and the transceiver, that:
controls the transceiver to receive information on traffic in application level from a network, and
steers the traffic from a first link to a second link according to the received information.
